(19) United States
(12) Patent Application Publication
(10) Pub. No.: US 2024/0402683 A1
(43) Pub. Date: Dec. 5, 2024

(54) ELECTRONIC COMPONENT DYNAMIC PICK AND PLACE OPERATIONS USING AUTOMATION SOFTWARE

(71) Applicant: International Business Machines Corporation, Armonk, NY (US)

(72) Inventors: Jeannette Bender, Highland, NY (US); Mateusz Koziol, Poughkeepsie, NY (US); Schuyler Mann, Poughkeepsie, NY (US); Joseph Scaglione, Poughkeepsie, NY (US); Karl Owen Casserly, Valley Stream, NY (US)

(21) Appl. No.: 18/326,690

(22) Filed: May 31, 2023

(51) Int. Cl. G05B 19/418; G06Q 10/0875

(52) U.S. Cl. CPC G05B 19/41805; G05B 19/41815; G05B 19/4183; G06Q 10/0875

(57) ABSTRACT

Picking and placing operations for assembling a hardware device using a tool that can include implementing an assembly operation of a hardware device having a workpiece, which includes positioning the workpiece on a workstation in proximity to proximity sensors. In a following step, an order may be assessed on an order system. Parts and specification data may be retrieved based on the order for the hardware device. Workstation inventory can be assessed for the workstation. Parts can then be pulled based on the order and the workstation inventory. A label can be scanned on the workpiece. Thereafter, using the tool dynamically picking and installing or uninstalling parts into required locations of the workpiece.

### STATEMENT REGARDING PRIOR DISCLOSURES BY THE INVENTOR OR A JOINT INVENTOR

The following disclosure(s) are submitted under 35 U.S.C. 102(b)(1)(A): Applicant is aware of certain confidential activities, which may constitute an offer for sale and which occurred within one year prior to the effective filing date of this application. The confidential activities were related to the Applicants' internal-only use of tools used to help provide generally available services to third parties.

### BACKGROUND

The present invention generally relates to electrical component manufacturing using automation technology controlled using computer software, for example using robotic technology.

Evolving system designs from generation to generation introduce challenges to tooling processes when precise plugging movements are required for assembly. Sorting processes should be performed dynamically to accommodate complex work presented. Custom order configurations can require decision making on the fly. Classic automated pick and place systems in the industry do not accommodate the complexity of custom order configurations, and simply pick and place in a repeated fashion for a few product types without the need for continuous inputs and change of actions.

### SUMMARY

In accordance with some embodiments of the present disclosure, computer implemented methods, systems and computer program products have been provided for an automated system and control mechanisms for dynamic pick and place operations utilizing collaborative robots.

In one aspect, a computer implemented method is provided for picking and placing operations for assembling a hardware device. The method can include implementing, using a tool, an assembly operation of a hardware device having a workpiece the includes positioning the workpiece on a workstation in proximity to proximity sensors. The method further includes accessing an order on an order system and retrieving parts and specification data based on the order for the hardware device. In a following step, the method can continue with assessing present workstation inventory for the workstation; and pulling parts based on the order and the workstation inventory. The method can further include reading a label on a part or the workpiece; and dynamically picking and installing or uninstalling parts using the tool into required locations of the workpiece.

In one embodiment, the method further includes detecting connection data and receiving communication data with respect to the workpiece, including a workpiece count. In the example wherein the workpiece is a plug, the method can further include receiving a plug force; detecting communication errors with equipment of the tool handling the workpiece on the workstation; and receiving the communication errors at a computer communicating with the tool.

In another aspect, a system for picking and placing operations for assembling a hardware device is described that includes a hardware processor; and a memory that stores a computer program product. The computer program product of the system when executed by the hardware processor, causes the hardware processor to implement, using a tool, an assembly operation of a hardware device having a workpiece which includes positioning the workpiece on a workstation in proximity to proximity sensors. The system when executing the computer program product can access an order on an order system and retrieve parts and specification data based on the order for the hardware device. The system can further assess the present workstation inventory for the workstation; and then pull parts based on the order and the workstation inventory. In a following step, the system can read a label on a part or the workpiece; and then dynamically install or uninstall parts, using the tool, into required locations of the workpiece.

In one embodiment, the system further includes to detect connection data and receiving communication data with respect to the workpiece, including a workpiece count. In the example wherein the workpiece is a plug, the system can further include to receive a plug force; detect communication errors with equipment of the tool handling the workpiece on the workstation; and receive the communication errors at a computer communicating with the tool.

In yet another aspect, the present disclosure describes a computer program product for dynamic pick and place operations utilizing collaborative robots. The computer program product can include a computer readable storage medium having computer readable program code embodied therewith. The program instructions executable by a processor to cause the processor to implement, using the hardware processor, an assembly operation of a hardware device having a workpiece, which includes positioning the workpiece on a workstation in proximity to proximity sensors. The computer instructions also can implement access, using the hardware processor, an order on an order system and retrieving parts and specification data based on the order for the hardware device. Further, the computer program product can provide that product assess, using the hardware processor, present workstation inventory for the workstation; and pulls parts based on the order and the workstation inventory. In following steps, the computer program product can read, using the hardware processor, a label on a part or the workpiece; and can installing or uninstalling parts into required locations of the workpiece

In one embodiment, the computer program product further includes to detect connection data and receiving communication data with respect to the workpiece, including a workpiece count. In the example wherein the workpiece is a plug, the computer program product can further include to receive a plug force; detect communication errors with equipment of the tool handling the workpiece on the workstation; and receive the communication errors at a computer communicating with the tool.

### BRIEF DESCRIPTION OF THE DRAWINGS

The following description will provide details of preferred embodiments with reference to the following figures wherein:

FIG. 1 is a front perspective view of an example environment in which the computer implemented methods, systems and computer program products have been provided for automated system and control mechanisms for dynamic pick and place operations utilizing robots, in accordance with one embodiment of the present disclosure.

FIG. 2 is a side perspective view of the example environment that is depicted in FIG. 1.

FIG. 3 is a flow/block diagram depicting a system for automated system and control mechanisms for dynamic pick and place operations utilizing robots, in accordance with one embodiment of the present disclosure.

FIG. 4 is a flow/block diagram showing a computer implemented method for automated system and control mechanisms for dynamic pick and place operations utilizing robots, in accordance with one embodiment of the present disclosure.

FIG. 5 is a flow/block diagram depicting an initial operation flow for configuring the robot for pick and place operations, in accordance with one embodiment of the present disclosure.

FIG. 6 is a flow/block diagram depicting an operation flow for the robot during pick and place operations, in accordance with one embodiment of the present disclosure.

FIG. 7 is a perspective view of illustrating a first example of a picker tool, in accordance with some embodiments of the present disclosure.

FIG. 8 is a perspective view of illustrating a second example of a picker tool, in accordance with some embodiments of the present disclosure.

FIG. 9 is a magnified view of a first gripper surface of the first example of the picker tool that is depicted in FIG. 7.

FIG. 10 is a magnified view of a second gripper surface of the second example of the picker tool that is depicted in FIG. 8.

FIG. 11 is a block diagram illustrating a system that can incorporate the system for dynamic pick and place operations utilizing robots that is depicted in FIG. 4, in accordance with one embodiment of the present disclosure.

FIG. 12 depicts a computing environment according to an embodiment of the present disclosure.

### DETAILED DESCRIPTION

The methods, systems, and computer program products described herein can provide for an automated system and control mechanism for dynamic pick and place operations utilizing robots. In some embodiments, the automated system and control mechanism for dynamic pick and place operations includes grippers for use with robot arms in pick-and-place operations, securing pods for storing pick/place product, a center location mechanism for positioning the receiving product to be held and assembled with the pick/place products, as well as scanner and a user interface (UI) that are all configured for pick and place assembly applications. In some embodiments, the automated systems described herein can utilize the mechanisms mentioned above, e.g., grippers, securing pods, center location mechanism, scanner and user interface (UI), with a system that employs code logic to dynamically pick and place cards in a precise arrangement. The high plugging precision and dynamic selection of trays/cards enables the ability to adapt to evolving systems with increasing package density and different suppliers with varying card and tray designs. Furthermore, the systems logic interacts with a logistics data server to retrieve order information, identify appropriate action, and dynamically plug a multiplicity of available card types into receiving products without the need to be specifically kitted in an order or follow a sequential build process.

It is noted that in the following description the “pick/place” products are circuit boards, such as printed circuit boards (PCB), which may include integrated circuits. Further, in the following description the “pick/place” products are circuit boards, such as printed circuit boards (PCB), which may include integrated circuits (ICs) and memory etc. The circuit boards for the pick/place products may be referred to as cards. The “receiving product” may be housing, e.g., having a draw geometry, that receivers the “pick/place” products, which can be circuit boards. The assembled combination of “pick/place” products and “receiving product” may be employed as a computer component, such as a server computer, e.g., as used in a mainframe application. It is noted that these are only example applications, as any combination of two computing elements being assembled may be the product produced by the automated system and control mechanisms for dynamic pick and place operations utilizing robots that is described herein.

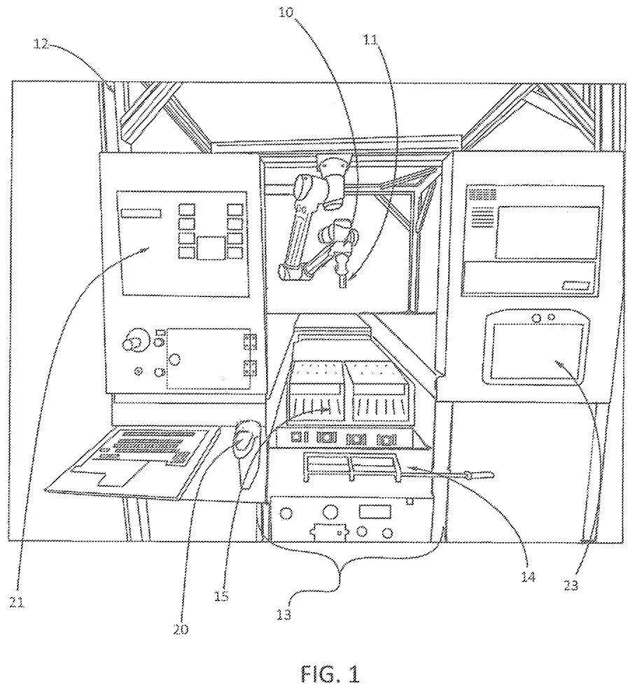

The methods, systems and computer program products of the present disclosure are now described in greater detail with reference to FIGS. 1-12.

FIG. 1 is an illustration of an example environment in which the computer implemented methods, systems and computer program products have been provided for automated system and control mechanisms for dynamic pick and place operations utilizing robots 10. In one example, the example environment may be referred to as a cobot workstation. A “cobot”, or collaborative robot, is a robot intended for direct human-robot interaction within a shared space, or where humans and robots are in close proximity. Cobot applications contrast with traditional industrial robot applications, in which robots are isolated from human contact.

In one embodiment, the system includes a robot 10, e.g., robot arm, through which the pick and place operations are executed. A robotic arm 10 is a type of mechanical arm, which in the present case may be programmable, with similar functions to a human arm. The robotic arm 10 may be the sum total of the mechanism or may be part of a more complex robot. The links of such a manipulator are connected by joints allowing either rotational motion (such as in an articulated robot) or translational (linear) displacement. The links of the manipulator can be considered to form a kinematic chain. The terminus of the kinematic chain of the manipulator is called the end effector and it is analogous to the human hand. The end effector may include a gripper 11. The gripper 11 is an element having at least two positions. A closed position of the gripper 11 may be employed to secure a card (“pick/place” product). An open position of the gripper 11 may be employed to release a card (“pick/place” product). Proximate to the end effector may also include a camera 17. The camera 17 may function as an optical sensor in the pick and place operations, as well as identifying the card (“pick/place” product) and the drawer 15 (“receiving product”) into which the cards (“pick/place” product) are inserted for assembly of the final product. The camera 17 may be employed to confirm the alignment of the cards (“pick/place” product) to the draw 15 (“receiving product”) into which the cards (“pick/place” product) are inserted for assembly of the final product. The camera 17 may also be employed to confirm alignment of the draw 15 (“receiving product”) with the assembly station portion 13 of a frame 12 to which the robot arm 10 may be engaged. The camera 17 may also be used to check alignment of the trays 18. The frame 12 may provide the supporting structure for all the components of the system in the example environment depicted in FIG. 1.

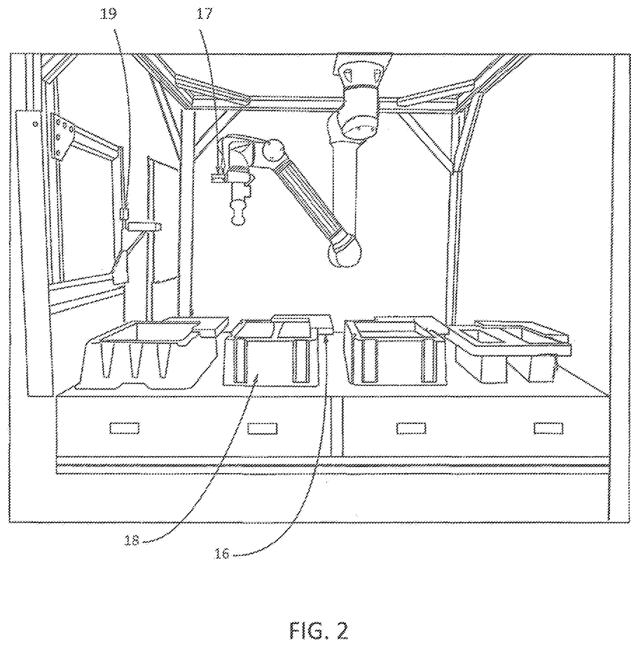

Referring to FIGS. 1 and 2, underlying the robot arm 10 is an assembly station portion 13 of the frame 12. The assembly station portion 13 of the frame is dimensioned to accept the draw 15 (“receiving product”) into which the cards (“pick/place” product) are inserted for assembly of the final product. The assembly station portion 13 may include different types of mechanisms for centering the receiving product, e.g., drawer 15, so that it may aligned for receiving pick/place products, e.g., cards, using the robot arm 10. For example, the assembly station portion 13 may include rollers for positioning the drawers 15. Further, the rollers can function as positioning elements to position the draw 15 along the left to right direction (and vice versa), as well as the front to back direction (and vice versa). Additionally, the assembly station portion 13 may have a plurality of bumpers to align the drawers 15. In other examples, the assembly station portion 13 of the frame may include vertical actuators, linear guides, stepper motors, and clamp brackets.

The frame 12 may also include securing pods 16. Securing pods 16 are used to secure/align trays 18 that hold the inventory of pick/place products, e.g., cards. The securing pods 16 may include actuators to change the height of the trays from which the pick/place products may be pulled. In some embodiments, the securing pods 16 can also include linear guides, stepper motors, and clamp brackets.

The assembly station portion 13 of the frame 12 may also include a retaining gate 14. The assembly station portion 13 of the frame may be a center location for a drawer 15 to be held and assembled. The retaining gate 14 may include an obstructing wall that can directly contact the drawer 15 while in the assembly station portion 13 of the frame 12. Proximate to the assembly portion of the frame 12 may be at least one proximity sensor, which can check the positioning of the drawer 15 during pick and place operations. The rollers provide for positioning and repositioning of the drawer 15. For example, the proximity sensor can indicate when a drawer 15 is present at the assembly station portion 13. Additionally, the robot arm 10 includes a camera 17, which may also function to confirm alignment of the drawer 15 in the assembly station portion 13 of the frame 12 for the pick and place operations.

The assembly station portion 13 of the frame 12 including the rollers and the retaining gate 14, as well as the proximity sensors (when present) and the robot arm 10 mounted camera 17, may all be elements of a “center location mechanism” for positioning the receiving product, e.g., drawer 15, to be held and assembled with the pick/place products, e.g., cards.

Referring to FIG. 2, the example environment in which the computer implemented methods, systems and computer program products have been provided for automated system and control mechanisms for dynamic pick and place operations utilizing robots may also include an inventory system for the cards (“pick/place” product). The cards may be memory modules, such as DIMM memory. A DIMM (Dual In-line Memory Module), commonly called a RAM stick, comprises a series of dynamic random-access memory integrated circuits. These memory modules are mounted on a printed circuit board and designed for use in personal computers, workstations, printers, and servers. In some embodiments, the DIMM memory may be CDIMM and/or DDIMM memory. DDIMM (DDIMM) refers to Double Data Rate 4 (DDR4) technology DIMMs. “Centaur” DIMM (CDIMM) are dense memory cards that include the “Centaur” buffer chips that were designed to offer very high bandwidth and include L4 cache memory segments to contribute greatly to performance. It is noted that the above description of cards is provided for illustrative purposes only and is not intended to limit the present disclosure, as any electrical component that can be employed in pick and place operations is suitable for use with the methods, systems and computer program products of the present disclosure.

The system includes storage trays 18, e.g., DIMM trays, in tray position regions of the frame 12 that are within the reach of the robot arm 10. For example, the storage trays 18 may be present on opposing sides of the assembly station portion 13 of the frame 12 at which the securing pods 16 are present. Although not depicted, in some embodiments, the assembly storage trays 18 may be present on only one side of the assembly station portion 13 of the frame 12. Additional storage for storage trays 18 that are not in use at the time of assembly using the pick and place operations may be in a lower portion of the frame 12.

The system also includes scanners 19, 20, which are an element that may be employed with the storage trays 18 to track inventory, as well as a mechanism to confirm component selection and installation in the pick and place operations.

Referring to FIG. 1, the scanner identified by reference number 20 is mounted to the front face of the frame 12 at which the user interface (UI) is also present. The scanner identified by reference number 20 may be referred to as a work unit scanner 20. The scanner on the front is for the operator 30 to use to scan in the initial work unit/part, e.g., drawer 15, to start working on. In some embodiments, the work unit scanner 20 may be an optical scanner. In some embodiments, an optical scanner is a device that performs optical character recognition and produces coded signals corresponding to the characters identified. The work unit scanner 20 may read a bar code on the drawer 15. In other embodiments, the work unit scanner 20 may read a bar code on a work order.

Referring to FIG. 2, the scanner identified by reference number 19 is mounted on a portion of the frame 12 that is facing the storage trays 18. The scanner identified by reference number 19 may be referred to as a DIMM scanner. Similar to the work unit scanner 20, the DIMM scanner 19 may be an optical scanner. The DIMM scanner 19 is what the robot 10 uses to scan each dimm/memory card during install or removal during the automated process. The DIMM scanner 19 scans the part into the system for inventory in connection with the pick and place operations.

Referring to FIG. 1, the example environment in which the computer implemented methods, systems and computer program products have been provided for automated system and control mechanisms for dynamic pick and place operations utilizing robots may also include a plurality of user interfaces (UI). For example, in some embodiments, the user interfaces (UIs) may include an operator user interface (UI) 21, which may include a LabVIEW interface (i.e., LabVIEW®). It is noted that the LabVIEW interface is only one example of an operator user inter (UI) 21 that may be used in accordance with the methods and systems of the present disclosure. For example, in some embodiments, the user interfaces (UI) may also include a manufacturing floor system (MFS) (which may also be referred to as a manufacturing execution system (MES)) 22. For example, in some embodiments, the user interfaces (UI) may further include a robot programable teach pendant interface 23. Each of the aforementioned user interfaces (UI) include an input device and/or software through which the user and the computers of the system may interact. In some embodiments, the input device may be a keyboard, however, touch screens, and other input devices, such as mouse input device, are equally applicable with the user interfaces (UI) described herein.

In some embodiments, the robot (e.g., COBOT) programable teach pendant interface 23 programs the robot 10 (e.g., COBOT) for where and when to move during the pick and place operations. The robot (e.g., COBOT) programable teach pendant interface 23 programs, tracks and monitors forces directed to the operation of the robot 10 (e.g., COBOT) for the pick and place operations. The manufacturing floor system (MFS) (which may also be referred to as a manufacturing execution system (MES)) 22 is a manufacturing logistics system that inventories the number of cards (“pick/place” products), type (e.g., configuration) of cards (“pick/place” products), drawer 15 (“receiving product”) types, installation sequences of cards (“pick/place” products) into drawers 15 (“receiving products”), and the manufacturing execution system (MES)) 22 can keep track of the number of cards (“pick/place” products) and drawers 15 (“receiving product”) during the pick and place operations.

The operator user interface (UI) 21, which may include a LabVIEW interface, is a user interface and central backend and communication pathway between the manufacturing floor system (MFS) (which may also be referred to as a manufacturing execution system (MES)) 22, the robot (e.g., COBOT) programable teach pendant 23 programs (as well as the robot 10), and the camera 17 that is mounted to the robot 10.

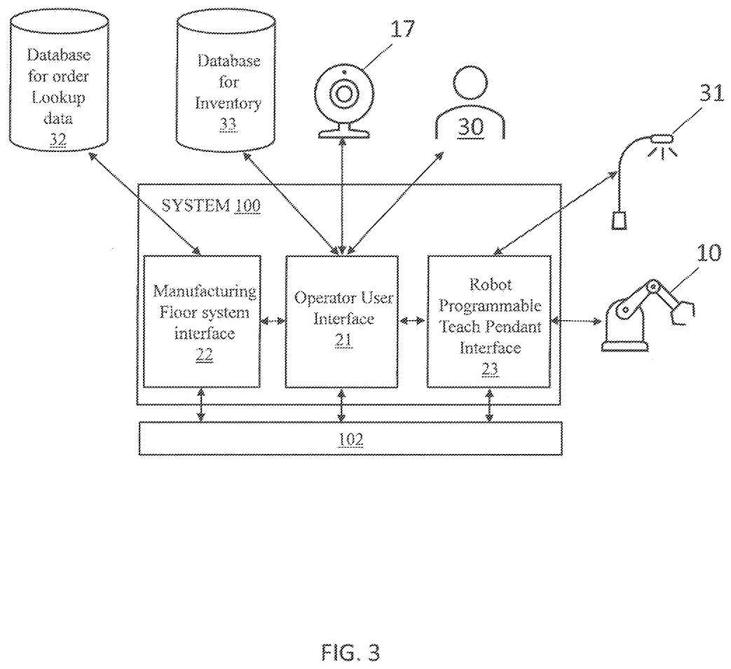

FIG. 3 depicts one embodiment of a system for automated system and control mechanisms for dynamic pick and place operations utilizing robots. The architecture overview depicted in FIG. 3 illustrates one embodiment of how the operator user interface (UI) 21, which may include a Lab VIEW interface, is a user interface and central backend and communication pathway between the manufacturing floor system (MFS) (which may also be referred to as a manufacturing execution system (MES)) 22, the robot (e.g., COBOT) programable teach pendant 23 programs (as well as the robot 10), and the camera 17 that is mounted to the robot 10.

The operator 30 enters commands into the system 100 and receives data reports from the system through the operator user interface (UI) 21, which can include a LabVIEW interface. For example, the operator 30 can scan, e.g., using the scanner 20, a work-unit that is being assembled to pull in the customer order information. The customer order information may include the configuration for the final product, e.g., including the type of drawer 15 (“receiving product”) type and the types of cards (“pick/place” products), as well as the configuration, e.g., slot placement of the specific card types into the drawer 15. The systems, methods and computer program products of the present disclosure may be adaptable for various card types, e.g., CDIMMs vs DDIMMs, and drawer types. In some embodiments, the securing mechanism acts an origin point and alignment for accurate pick/place & accommodates several tray sizes.

The operator user interface 21, e.g., LabVIEW, uses the MFS work unit, e.g., order configuration, to retrieve information from a database server 32. A database management system may work with the operator user interface 21 to provide that multiple databases can be accessed from the database server 32 for order lookup. The database management system may work with the operator user interface 21 to provide MFS error checking.

The operator user interface 21, e.g., LabVIEW, is also in communication with a server to access a database 33 (inventory database) that keeps inventory on the cards in the pick and place system, e.g., the cards in the DIMM trays 18. The inventory database 33 may also process record keeping.

The operator user interface 21 may be in communication with the database server 32 and the inventory database 33 of a secure, encrypted mainframe terminal emulation service over the Internet. For example, the database server 32 and the inventory database 33 may be internet based.

Referring back to FIG. 3, in some embodiments, the user interface (UI) 21 may be in electrical communication with the camera 17 that in some embodiments may be mounted to the robot 10. The camera 17 may be used to identify which tray 18 was placed into the assembly portion 13 of the frame 12. The camera 17 can check the angle of the trays, e.g., alignment of drawer 15 and trays that contain the cards, for proper alignment.

Referring to FIG. 3, the operator user interface 21 is also in communication with the robot (e.g., COBOT) programable teaching pendant 23, which is a separate user interface from the operator user interface 21. The communication between the operator user interface 21 and the robot (e.g., COBOT) programable teach pendant 23 and the camera 17 may be by local ethernet line connection.

The robot (e.g., COBOT) programable teaching pendant 23 is in communication with robot 10 to execute actions via for the pick and play operations in accordance with the aforementioned described strategies, methods and program flows. The robot (e.g., COBOT) programable teaching pendant 23 can also control an ionizer 31 during the pick and play operations.

The architecture depicted in FIG. 3 when incorporated with the environment for the computer implemented methods, systems and computer program products have been provided for automated system and control mechanisms for dynamic pick and place operations utilizing the robot 10 depicted in FIGS. 1 and 2 can be employed in a strategy that includes employing the robot teach pendant programs 23 for operating the robot arm 10, e.g., COBOT, where and when to move in the pick and place operations. The robot teach pendant programs 23 can also track and monitor forces. The operator user interface 21, e.g., LabVIEW, provides the user interface and central backend and communication pathway between the manufacturing floor system (MFS) frontend 22, the robot (e.g., COBOT) 10, and the camera 17. The computer implemented methods, systems and computer program products can be adaptable for various card types, e.g., CDIMMs vs DDIMMs, and trays, e.g., the concepts described herein are adaptable to multiple supplier card and tray designs. A securing mechanism, such as the securing pods 16 and/or the retaining gate 14, that acts an origin point and alignment for accurate pick/place & accommodates several tray 18, e.g., DIMM tray, sizes. The computer implemented methods, systems and computer program products can use the MFS Work Unit (Order Config) to retrieve information via a database server 32, in which a database management system, e.g., DB2, may work with the operator user interface 21 to provide that multiple databases can be accessed from the database server 32 for order lookup. The database server may also be referred to as database for order lookup 32. Information relevant to the order lookup can include drawer 15 information, such as drawer identification by manufacturer, card characteristics, such as memory card sizes, e.g., 64 GB, 128 GB, etc). The information relevant to order lookup may also include assembly information, such as slot location, e.g., (LG01, LG02, etc.). The order information retrieved by the MFS 22 can further include action performed based on installation value, the MFS 22 can retrieve data to check test levels, and the MFS 22 can retrieve data to check quality flags. The MFS 22 can also maintain installation records.

The computer implemented methods, systems and computer program products have been provided for automated system and control mechanisms for dynamic pick and place operations utilizing the robot 10 can account for different card (DIMM) type and size locations. For example, when the operator 30 is changing containers, e.g., DIMM trays 18, on the tray locations of the frame 12 from which the robot 10 will pick cards for pick and place operations, the operator 30 can scan part (e.g., PIN) numbers, e.g., using the scanner 20, to assign size and type for the cards within the trays to that location.

The computer implemented methods, systems and computer program products have been provided for automated system and control mechanisms for dynamic pick and place operations utilizing the robot 10 can provide for dynamic tray selection and card installation, and the system 100 can ask the operator 30 to restock trays 18 for required parts, e.g., cards, if they are not available at the time of the pick and place operations. The system 100 can send these messages through the operator user interface 21.

In some embodiments, the robot 10 will keep a counter of the cards being picked from the trays 18, which is reset on a container change, e.g., changing a DIMM tray 18. For example, the parts can be claimed to MFS (Manufacturing Floor System) client 22 during installation. The MFS client 22 can facilitate accurate tracking of part movements (inventory), plug force, plug counts, and installation/removal errors.

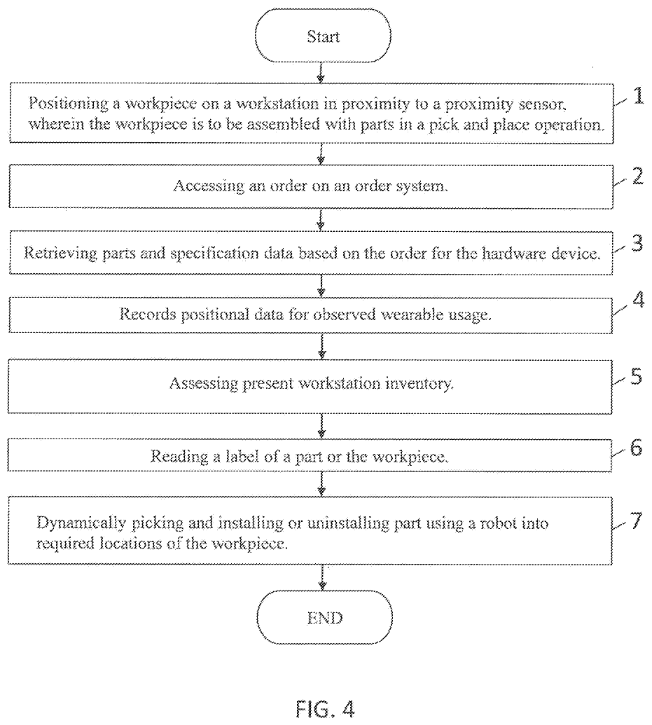

FIG. 4 illustrates one embodiment of the steps of a computer implemented method for picking and placing operations for assembling a hardware device.

The method can include implementing, using a tool, e.g., robot 10, an assembly operation of a hardware device having a workpiece the includes positioning the workpiece on a workstation in proximity to proximity sensors at block 1. The workpiece can be the drawer 15, and the workstation can include the assembly portion 13 of the frame 12. The proximity sensor can detect when the drawer 15 is present in the assembly portion 13 of the frame 12. The frame 12 also includes a mount for the robot 10, as well as a location for positioning the inventory of cards, e.g., trays 18 of cards, such as DIMM card trays.

Block 2 of the method may further include accessing an order on an order system. The order may be accessed by the operator 30 scanning an order using the scanner 20 that is in communication with the manufacturing floor system 22, e.g., LabVIEW, that provides the interface of the user with the system for picking and placing operations for assembling a hardware device.

The method may continue to block 3. Block 3 may include retrieving parts and specification data based on the order for the hardware device. Retrieving the parts and the specification data may include employing the manufacturing floor system 22 to retrieving the information from databases, e.g., cloud based databases (database server 32).

In block 4, the method may continue with assessing the present workstation inventory for the workstation. The inventory can be stored in the trays 18, e.g., DIMM trays 18. The inventory can be confirmed using the scanner 19 that is facing the trays 18. The manufacturing floor system 22 keeps inventory retrieving the information from databases, e.g., cloud based databases (database server 32).

The computer implemented method can continue to block 5, which can include pulling parts based on the order and the workstation inventory. Pulling parts may be executed using the robot 10, which pulls cards from the trays 18.

Block 6 may include reading a label on a part or the workpiece. The part may be read using the scanner identified by reference number 19 in FIG. 1. Reading the label on the part being picked is to confirm that an error has not occurred in picking parts for installation into the drawer 15.

Block 7 further includes dynamically picking and installing or uninstalling parts using the tool, e.g., robot 10, into required locations of the workpiece, e.g., drawer 15.

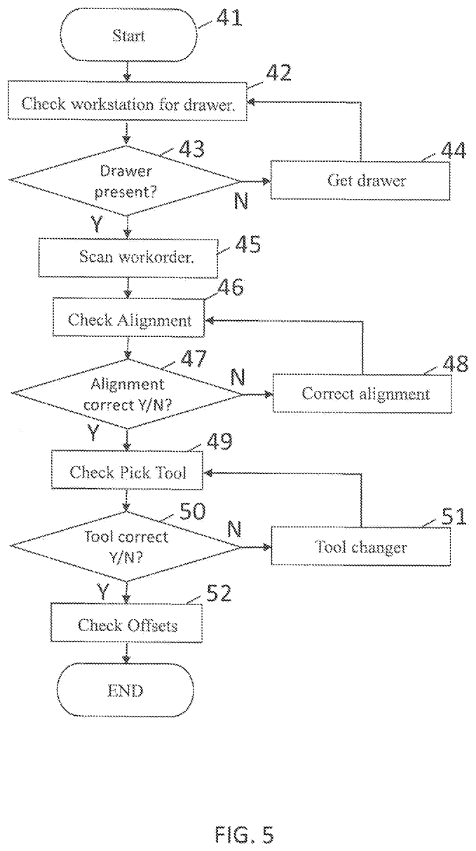

FIG. 5 is a flow chart illustrating one embodiment of a robot, e.g., COBOT, program flow for the initial steps for start up of a pick and place assembly sequence. The code program flow depicted in FIG. 5 is one embodiment of the present disclosure that may be employed by the robot programmable teach pendant 33 in accordance with the method described with reference to FIG. 4. The process depicted in FIG. 5 begins with the program starting at block 41, which can be when the operator 30 interacts with the user operator interface 21, because the user operator interface 21 and the robot programable teaching pendant interface 23 are in communication with one another, as depicted in FIG. 3.

Turning to block 42, the method can continue with detecting whether a workpiece, e.g., drawer 15, is present on the assembly station portion 13 of the frame 12 that the robot arm 10 is mounted to. In some embodiments, a proximity sensor may be used to determine whether the workpiece, e.g., draw 15, is present.

If the drawer 15 is not present at block 43, the method may continue with getting a drawer 15. To drawer 15 may be positioned in the assembly portion 13 of the frame 12. The retaining gate 14 may also contribute to aligning the drawer 15 at the assembly portion 13 location.

Turning to block 45, the method may continue with the operator 30 scanning a work unit. The operator 30 can scan the work unit using the scanner 20 mounted on the face of the frame 12 that is also providing support for all the user interfaces 21, 22, 23, as depicted in FIG. 1. This step is employed to pull into the system the custom order information, e.g., information related to the card type, e.g., DDIMM or CDIMM, the card size, e.g., 64 GB or 128 GB, the drawer type, and installation instructions, e.g., which cards are installed into which slots of the drawer 15.

The method may continue to checking the alignment of the drawer 15 at block 46. Alignment of the drawer 15 may be accomplished using rollers and bumpers for positioning and securing the drawer 15 thereon. Further, a securing gate 14 can retain the drawer 15 from being traversed out of the assembly portion 13 of the frame 12. The alignment can be confirmed using proximity sensors, as well as the camera 17 that is mounted to the picker end of the robot arm 10.

At block 47, a reposition alignment step may be performed is the drawer is not aligned at block 46. The reposition alignment step may be performed using the robot arm 10. The robot 10 may apply repositioning forces to the drawer 15 at the assembly portion 13 of the frame 12.

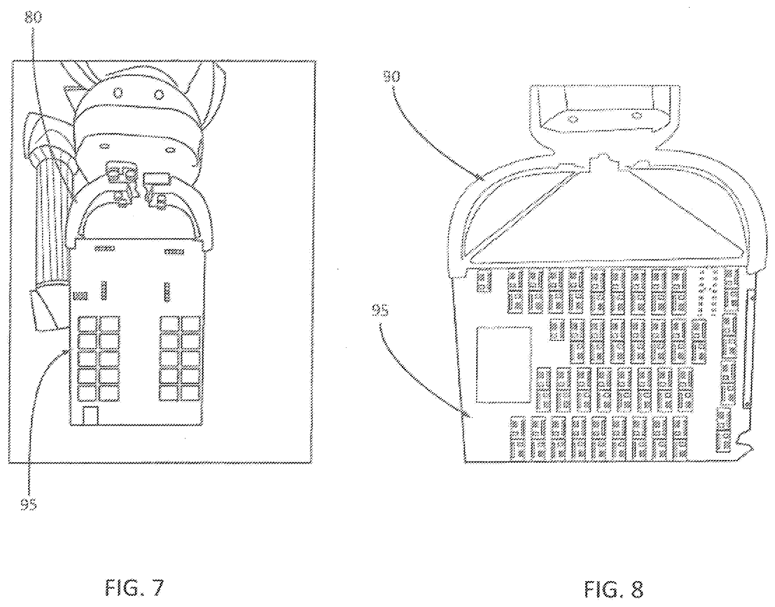

If the drawer is aligned at block 46, the method may continue to block 49 for checking the system to determine if the correct picking tools are available to the arm of the robot 10 for picking cards in accordance with the custom order information that has been pulled into the system at block 42 when the operator scanned the work unit. In some embodiments, the type of pick/place product, e.g., cards, such as CDIMM or DDIMM, may require different picker tools to remove the pick/place product, e.g., cards, from the trays 18. FIGS. 7-10 illustrate some embodiments of the different types of picker tools 80, 90. The picker tools generally have different geometries to correspond with the different sizes for the different types of pick/place products, e.g., cards, such as CDIMM or DDIMM.

If a change is needed for the picker tools at block 50, the process flow may continue with the arm of the robot 10 being traversed to a tool changer 51 so that the gripper 11 of the robot arm can be configured with the appropriate picker tool for the pick/place product, e.g., card, such as DDIMM or CDIMM card. The picker head (also referred to gripper head) may be configured based on card type being pulled from the MFS system. Changes in picker heads may be performed on the fly based upon which card is needed.

If no changes are needed for the picker tools at block 50, the method may proceed to a final contact offset check at block 52. The robot 10 may touch the drawer 15 at multiple points to check the alignment for the pick and place operations. This block may be the end of the initial steps for start up of a pick and place assembly sequence.

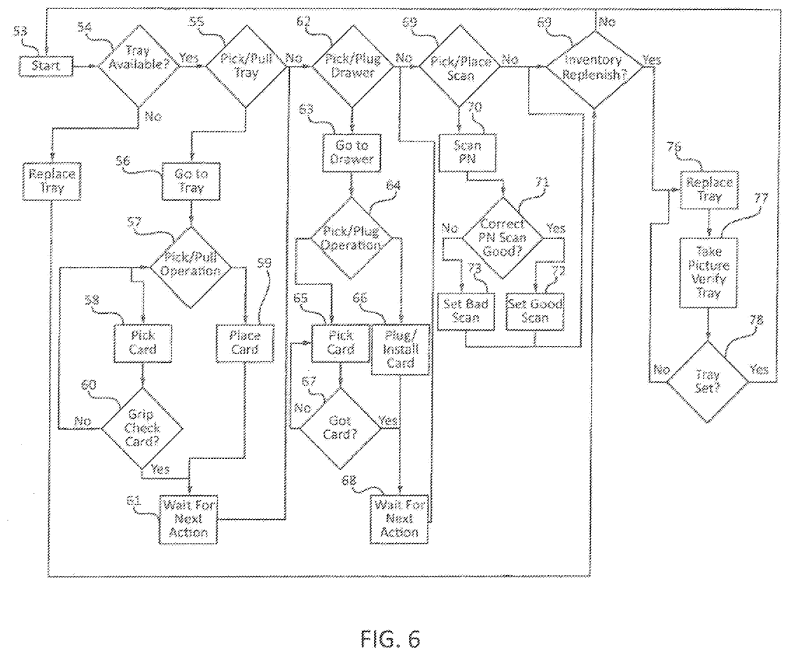

FIG. 6 is a flow/block diagram depicting an operation flow for the robot 10 during pick and place operations. The pick and place operation flow begins at block 53. At block 54, the method determines if a drawer 15 is configured and available for the pick and place operations, whether a tray 18 is available with cards available for pick and/or place relevant to a customer order for the drawer 15 that is present in the assembly portion 13 of the frame 12 in a securing pod 16. If an appropriate tray 18 is available at 54, the method continues to block 55 at which a determination is made if a pick operation or a pull operation is to be performed in connection with the tray 18. Turning to block 56, the robot may then go to a tray 18 having appropriate pick/place product, e.g., cards, such as CDIMM or DDIMM cards. The robot 10 then advances to a pick operation or a place operation at block 57. A determination is then made as to whether a pick/place product, e.g., card, such as CDIMM or DDIMM card, is to be picked at block 58 or a pick/place product, e.g., card, such as CDIMM or DDIMM card, is going to be placed at block 59. If the card is going to be picked at block 58, a determination is also made if the correct tool, i.e., picker tool, is being employed by the robot 10 to pick the specified card from the tray 18 at block 60. At the end of the cycle of blocks 58, 59 and 60, the robot 10 may have to wait for the next series of operations at block 61. This represents a first loop of pick and play operations at the tray 18.

The operation flow for the robot 10 during pick and place operations may then proceed to a loop at which the robot proceeds to a workpiece, e.g., drawer 15, at blocks 62 and 63. The method continues to block 64 at which a determination is made if a pick operation or a pull operation is to be performed in connection with the drawer 15. For example, the robot 10 will plug/install a pick/place product, e.g., card, such as CDIMM or DDIMM card, into the drawer 15 at block 66, or the robot 10 will pick a pick/place product, e.g., card, such as CDIMM or DDIMM card, from the drawer 15 at block 65. If the card is going to be picked at block 65, a determination is also made if the correct tool, i.e., picker tool, is being employed by the robot 10 to pick the specified card from the drawer 15 at block 67. At the end of the cycle of blocks 65, 66 and 67, the robot 10 may have to wait for the next series of operations at block 68. This represents a second loop of pick and play operations at the drawer.

The operation flow for the robot 10 during pick and place operations may then proceed to a scan loop at which the robot scans pick/place products, e.g., cards, such as CDIMM or DDIMM cards, at blocks 69 and 70. The scan is to track inventory of the pick/place products in the system, e.g., within the trays 18. The scans also are used to confirm correct installation in the second loop at the drawer 15. The scanner may be provided by the scanner identified by reference number 19 in FIG. 2. The scan at block 70 is then interpreted at block 71. If the pick/pull product, e.g., card, is scanned and the part number matches the intended pick/pull, the scan is set as a good scan at block 72. If the card is pick/pull product, e.g., card, is scanned and the part number does not match the intended pick/pull, the scan is set as a bad scan at block 73. The scan categorization is then used to confirm whether the workpiece, e.g., drawer 15, has been correctly assembled with pick/pull products, e.g., cards, and the inventory of cards can be updated. This represents a third loop of pick and play operations at the drawer. At the end of the cycle of blocks 71, 72 and 73, the robot 10 may then proceed to an inventory loop.

The inventory loop begins at block 75, e.g., with determining whether an inventory of pick/place products needs to be replenished. The inventory of pick/place product, e.g., cards, can be replenished by replacing empty trays 18 at block 76. At block 77 the inventory of the tray 18 may be photographed, e.g., using the camera 17 mounted to the robot. The imaging step at block 77 is to confirm that inventory has been replenished. At block 78 a determination is made whether the inventory that has been replenished at blocks 77 and 78 is correct. This represents a fourth loop of pick and play operations. At the end of the cycle of blocks 77 and 78, a determination is made whether the operations of loops 1, 2 3 and 4 may be repeated. This continues until the configuration of the drawer is completed by final assembly of the totality of pick/place products, e.g., cards, into the receiving product, e.g., drawer.

FIGS. 7 and 8 illustrate two picker tools 80, 90 having dimensions for engaging different dimensioned pick/place products 95, e.g., cards, such as CDIMM or DDIMM cards.

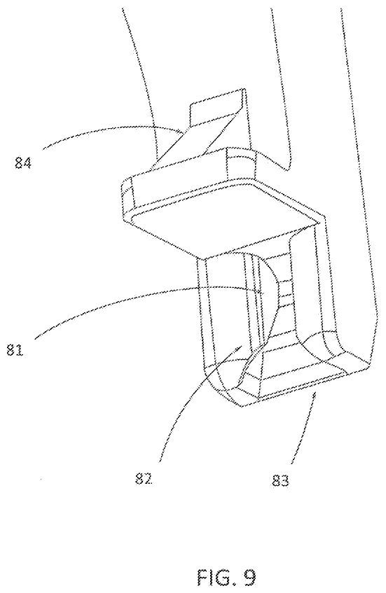

FIG. 9 is a magnified view of a first gripper surface of a first embodiment of a picker tool 80 that is depicted in FIG. 7. The gripper surface of the picker tool 80 may include a curvature 81 to mate with specific pick/place products 95, e.g., cards, such as CDIMM or DDIMM cards. Still referring to FIG. 9, the gripper surface may further include specific chamfers identified by reference numbers 82 and 83 to the space requirements for engaging the size and space requirements of the pick/place products 95, e.g., cards, such as CDIMM or DDIMM cards. The picker tool 80 may include additional features for strength & flexibility needs identified by reference number 84.

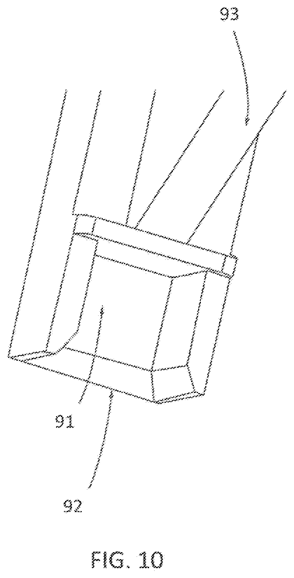

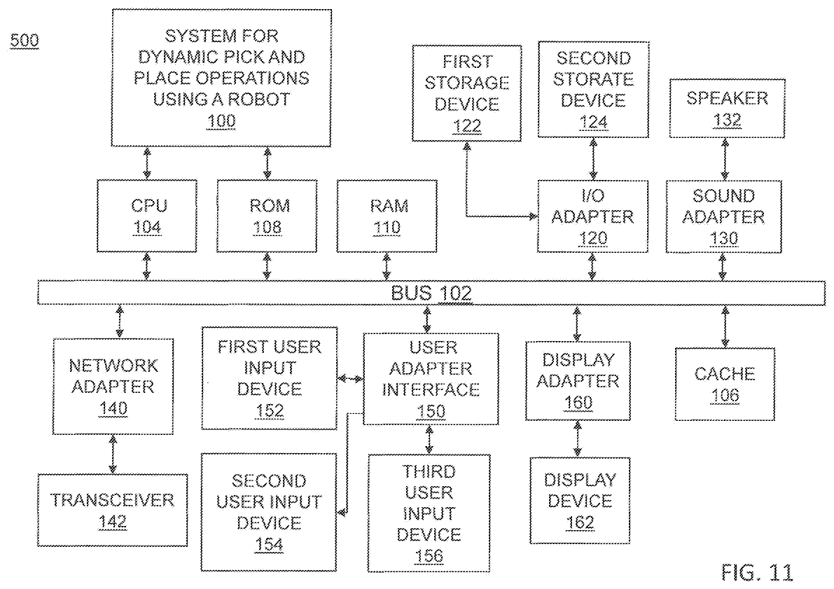

FIG. 10 is a magnified view of a second gripper surface of a second embodiment of a picker tool 90 that is depicted in FIG. 8. The picker tool 90 may include a frame 91 to mate with specific pick/place products 95, e.g., cards, such as CDIMM or DDIMM cards. The picker tool 90 may include specific chamfers identified by reference number 92 to meet the size and space requirements of the pick/place products 95, e.g., cards, such as CDIMM or DDIMM cards. The picker tool 90 may include additional features for strength & flexibility needs identified by reference number 93.

The computer implemented methods, systems and computer program products that are described herein can dynamically plug cards based on customer order using the multiplicity of available card types in the station without the cards needing to be specifically kitted in order and without the need to follow/build sequentially. The computer implemented methods, systems and computer program products that are described herein can pull in order information from server and selects actions based on the installed part status provided in the information (pick/plug). The programs can connect to order systems (e.g., to pull data from various data forms, e.g., spreadsheets, and manufacturing floor systems), which can provide part numbers for pick/plug products, e.g., cards, and installation locations in the receiving product, e.g., slot location in a drawer receiving the cards.

The system 100 can read data (e.g., in the environment depicted in FIGS. 1 and 2), and can identify what is present in the physical workstation (e.g., frame including storage location for the trays) (e.g., number of cards available, part #s, and tray 18 types).

Based on what the order calls out from what the operator 30 scans into the system using the scanner 19, and what inventory is present in the trays 18, the system either starts assembly process or prompts the user for additional inputs (to replace parts). In some embodiments, the program for the operator user interface 21 can push and pulls data from MFS (Manufacturing Floor System) 22, and then to the client system to claim the parts.

The computer implemented methods, systems and computer program products that are described herein can dynamically select trays 18 to pick from based on aspects, such as (number of cards remaining, type of card, type of tray, auto reassignment)

The computer implemented methods, systems and computer program products that are described herein can employ visual recognition, e.g., through the camera 17 mounted to the robot 10, in conjunction with logic I/O to identify unique tray type and independently assign tray ID which drives appropriate pick/place locations.

In some embodiments, the program code goes through a series of checks per tray location identifying what is present (part #, product type, number of cards) then uses these inputs to select which tray is the best option for the configuration of installation for the drawer 15.

In some embodiments, during installation, the computer implemented methods, systems and computer program product can looks for same card type with the least amount of cards present. In some embodiments, during removal of pick/place products, e.g., cards into the receiving product, e.g., drawer 15, the computer implemented methods, systems and computer program products can look for the same card types with the most available amount of cards if not full, then empty.

Referring to FIG. 3, in some embodiments, the components of the dynamic pick and place operations using a robot 100 are interconnected by a bus 102. The bus 102 may also be in communication with at least one hardware processor, in which the hardware processor 9 may function with the other elements depicted in FIG. 3 to provide the functions described above. FIG. 11 further illustrates a processing system 500 that can include the dynamic pick and place operations using a robot 100 that is described with reference to FIGS. 1-3. The exemplary processing system 500 to which the present invention may be applied is shown in accordance with one embodiment. The processing system 500 includes at least one processor (CPU) 104 operatively coupled to other components via a system bus 102. The system bus 102 may be in communication with the system 100. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. As illustrated, the system 100 that provides for provenance based identification of policy deviations in cloud environments can be integrated into the processing system 400 by connection to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 400.

Of course, the processing system 500 may also include other elements (not shown), as readily contemplated by one of skill in the art, as well as omit certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 500 are readily contemplated by one of ordinary skill in the art given the teachings of the present invention provided herein.

The present invention may be a system, a method, and/or a computer program product at any possible technical detail level of integration. For example, in some embodiments, a computer program product is provided for dynamic pick and place operations using a robot. The computer program product can include a computer readable storage medium having computer readable program code embodied therewith. The program instructions executable by a processor to cause the processor to implement, using the hardware processor, an assembly operation of a hardware device having a workpiece, which includes positioning the workpiece on a workstation in proximity to proximity sensors. The computer instructions also can implement access, using the hardware processor, an order on an order system and retrieving parts and specification data based on the order for the hardware device. Further, the computer program product can provide that product assess, using the hardware processor, present workstation inventory for the workstation; and pulls parts based on the order and the workstation inventory. In following steps, the computer program product can read, using the hardware processor, a label on a part or the workpiece; and can installing or uninstalling parts into required locations of the workpiece.

The computer program product may include a computer readable storage medium (or media) having computer readable program instructions thereon for causing a processor to carry out aspects of the present invention. The computer program produce may also be non-transitory.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAS, and/or PLAs.

These and other variations of a hardware processor subsystem are also contemplated in accordance with embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

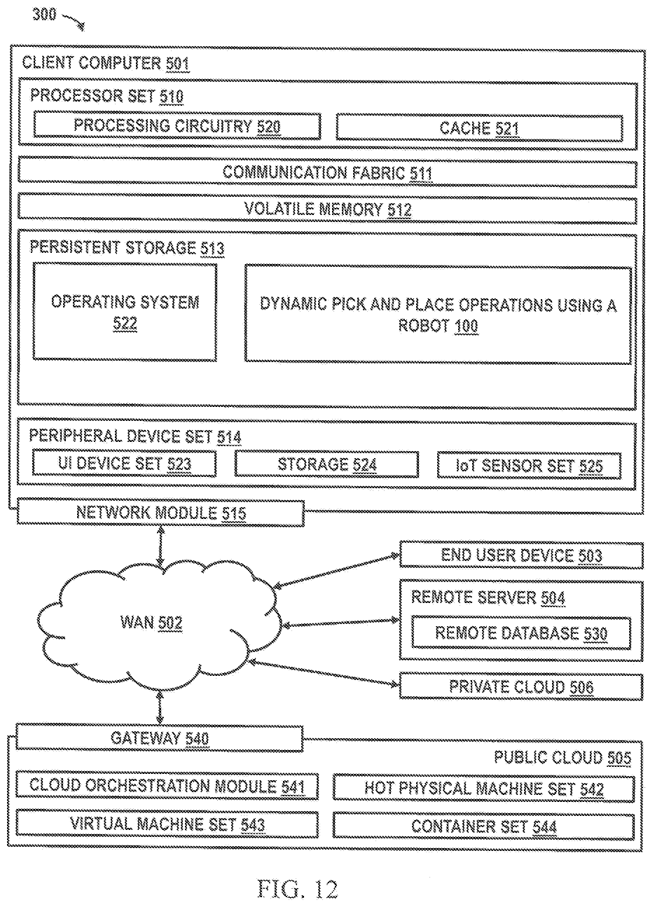

Referring to FIG. 12, the computing environment 300 contains an example of an environment for the execution of at least some of the computer code involved in performing the inventive methods, such as the method for dynamic pick and place operations using a robot 100. In addition to block 100, computing environment 300 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 100, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 501, to keep the presentation as simple as possible.

Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 300, at least some of the instructions for performing the inventive methods may be stored in block 200 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in block 100 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 101 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 101 to communicate with other computers through WAN 102. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515. WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method for dynamic pick and place operations using robots (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer implemented method for picking and placing operations for assembling a hardware device comprising:
determining, using a computer, an assembly operation of a hardware device having a workpiece that includes the workpiece being positionable on a workstation in proximity to proximity sensors;
determining which parts and specification data to retrieve and access based on an order for the hardware device;
assessing, using the computer, workstation inventory data;
determining which parts to pull based on the order and the workstation inventory;
interpreting, using the computer, a readable label on a part or the workpiece; and
determining, using the computer, and sending an operational instruction to a tool communicatable with the workpiece to dynamically pick and install or uninstall a part on a location of the workpiece.

2. The computer implemented method of claim 1, wherein the tool is a robot arm.

3. The computer implemented method of claim 1, wherein the part for dynamically picking and installing or uninstalling are memory cards.

4. The computer implemented method of claim 3, wherein the workpiece is a drawer providing a housing for the memory cards in a server application.

5. The computer implemented method of claim 1, further comprising:
determining a gripper head based on the label or the order;
engaging the gripper head on the tool; and
employing the gripper head to engage the part.

6. The computer implemented method of claim 1, wherein reading a label on a part or the workpiece further comprises employing a scanner to scan a bar code.

7. The computer implemented method of claim 1, wherein the positioning of the workpiece on the workstation includes a retaining gate to align the workpiece.

8. The computer implemented method of claim 1, wherein the positioning of the workpiece on the workstation includes rollers to align the workpiece.

9. A system for picking and placing operations for assembling a hardware device comprising:
a hardware processor; and
a memory that stores a computer program product, the computer program product when executed by the hardware processor, causes the hardware processor to:
implement, using a tool, an assembly operation of a hardware device having a workpiece that includes positioning the workpiece on a workstation in proximity to proximity sensors;
access an order on an order system;
retrieve parts and specification data based on the order for the hardware device;
assess workstation inventory for the workstation;
pull parts based on the order and the workstation inventory;
read a label on a part or the workpiece; and
dynamically install or uninstall parts, using a tool, into required locations of the workpiece.

10. The system of claim 9, wherein the tool is a robot arm.

11. The system of claim 9, wherein the part for dynamically picking and installing or uninstalling are memory cards.

12. The system of claim 11, wherein the workpiece is a drawer providing a housing for the memory cards in a server application.

13. The system of claim 9, further comprising:
determine a gripper head based on the label or the order;
engage the gripper head on the tool; and
employ the gripper head to engage the part.

14. The system of claim 9, wherein reading a label on a part or the workpiece further comprises employing a scanner to scan a bar code.

15. A computer program product for picking and placing operations for assembling a hardware device, the computer program product can include a computer readable storage medium having computer readable program code embodied therewith, the program instructions executable by a processor to cause the processor to:
implement, using the hardware processor, an assembly operation using a tool of a hardware device having a workpiece which includes positioning the workpiece on a workstation in proximity to proximity sensors;
access, using the hardware processor, an order on an order system and retrieving parts and specification data based on the order for the hardware device;
assess, using the hardware processor, present workstation inventory for the workstation;
pull, using the hardware processor, parts based on the order and the workstation inventory;
read, using the hardware processor, a label on a part or the workpiece; and
installing or uninstalling parts, using the hardware processor, into required locations of the workpiece.

16. The computer program product of claim 15, wherein the tool is a robot arm.

17. The computer program product of claim 15, wherein the part for dynamically picking and installing or uninstalling are memory cards.

18. The computer program product of claim 17, wherein the workpiece is a drawer providing a housing for the memory cards in a server application.

19. The computer program product of claim 15, further comprising:
determine a gripper head based on the label or the order data for the part;
engage the gripper head on the tool; and
employ the gripper head to engage the part.

20. The computer program product of claim 15, wherein the to read a label on a part or the workpiece further comprises employing a scanner to scan a bar code.
